(19) United States
(12) Patent Application Publication
(10) Pub. No.: US 2004/0222271 A1
(43) Pub. Date: Nov. 11, 2004

(54) Method and pallet assembly for reflow soldering of interconnections between printed circuits having low-temperature substrates

(75) Inventors: Mark Tor, Sterling Heights, MI (US); Peter J. Sinkunas, Canton, MI (US); Lahki N. Goenka, Ann Arbor, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/430,970

(22) Filed: May 6, 2003

(51) Int. Cl. B23K 31/02; B23K 37/04

(52) U.S. Cl. 228/180.21; 228/49.5

(57) ABSTRACT

A method and associated pallet assembly for reflow soldering electrical interconnections between a pair of printed circuits, at least one of which features a relatively-low-softening-temperature substrate, includes fixturing the printed circuits between the mating surfaces of a pallet and a cover, wherein the cover includes a first aperture adapted to expose an area on the back face of the first printed circuit. When the palletized printed circuits are advanced through a reflow oven, a nozzle directs hot gases through the first aperture to impinge directly upon the back face of the substrate to thereby reflow a solder layer sandwiched between the respective substrates of the printed circuits. Additional components on the second printed circuit are advantageously soldered in the same pass as hot gases from the nozzle flow through a second aperture defined in the pallet assembly's cover to impinge upon an additional solder layer on the second printed circuit.

### FIELD OF INVENTION

The invention relates to reflow soldering of interconnections between printed circuits which themselves feature a thin, relatively-low softening temperature polymeric substrate, such as PET or FR4 substrates.

### BACKGROUND OF THE INVENTION

It is becoming, increasingly desirable to manufacture flexible printed circuits which utilize a thin, polymeric substrate, such as polyethylene terephthalate (PET) or Fiberglass Resin (FR4), whose relatively-low-temperature softening point approaches the melting point of conventional solder. The prior art has recognized that, upon seeking to electrically interconnect two of such printed circuits, the heat typically applied to the interconnect in order to reflow a solder paste applied to one or the other of the printed circuits may cause unwanted distortion or heat-stressing of the substrate material, thereby lowering process yields and substantially increasing unit costs.

In order to avoid such heat-induced distortion or heat-stressing of the substrate material of one or both printed circuits, the prior art has resorted to point-to-point laser soldering process, characterized by the precise and extremely localized heating of the solder joints to thereby avoid the direct heating of either substrate while minimizing any indirect heating of either substrate. Unfortunately, this approach results in a significantly lower throughput rate and significantly increased processing costs, thereby similarly preventing high-volume processing of such interconnections that might other provide a low unit cost.

Accordingly, what is needed is a low-cost method for high volume reflow soldering of electrical interconnections between printed circuits having PET or FR4 substrates.

### BRIEF SUMMARY OF THE INVENTION

Under the invention, a method for reflow soldering electrical interconnections between a pair of printed circuits, for example, between a pair of printed circuits having PET substrates, or a printed circuit having a PET substrate with another printed circuit having an FR4 substrate, includes fixturing the two printed circuits between a respective mating surface of pallet and a cover of a pallet assembly such that the printed circuits are overlapped with solder layers disposed between respective traces on the first faces of the printed circuits, and such that a first portion of the cover defining an aperture extending from the cover's top surface to its mating surface exposes a first area of the second face of the first printed circuit's substrate underlying the solder layers. The method further includes directing hot gases at the top surface of the cover of the pallet assembly to impinge directly on the first area of the first printed circuit's substrate until the solder layers are heated to a predetermined reflow temperature.

In accordance with an aspect of the invention, the perimeter of the first aperture, as defined by the first portion of the pallet assembly's cover, shields a continuous perimeter of the first area of the first printed circuit's low-softening-temperature substrate from a direct impingement of hot gases during the directing step. Accordingly, the first portion of the cover is preferably dimensioned to prevent heating a continuous perimeter of the first area of the first printed circuit's substrate to a predetermined temperature that is correlated with the respective softening temperatures of the two printed circuits. Further, with the directing step preferably includes advancing the fixtured first and second printed circuits past a nozzle of a reflow oven at a predetermined velocity, and supplying hot gases to the nozzle at a predetermined temperature inflow rate, whereby the rate of convective heat transfer to the substrate of the first printed circuit is precisely controlled. In this manner, the invention provides for the direct heating of the substrate of the first printed circuit in order to indirectly reflow the solder layers, without causing unwanted distortion or heat-stressing of the substrate material of the first printed circuit.

In accordance with another aspect of the invention, the cover of a first exemplary pallet assembly is formed of a thermally-insulative material, such as a fiberglass-epoxy resin, to further preventing unintended convection heating of the substrate of either printed circuit while the pallet assembly is advanced through the reflow oven. Alternatively, where the pallet assembly's cover is formed of a thermally-conductive material, such as aluminum, the method includes conducting heat away from the substrate of the first circuit board in touching contact with the cover, whereby unintended convection heating of the substrate of either printed circuit is likewise mitigated.

In accordance with yet another aspect of the invention, the fixturing step preferably includes clamping the first and second printed circuits together proximate to the solder layers when directing hot gases through the first aperture of the cover, whereby the solder layers are maintained in contact with the respective traces of the first and second printed circuits during the resulting solder reflow.

In accordance with yet another aspect of the invention, where the cover of the pallet assembly further includes a second aperture extending between its top and mating surfaces, adjacent to the first portion of the cover and adapted to expose a first area on the first face of the second printed circuit on which one or more surface-mounted components are to be soldered by an additional solder layer, the directing step of an exemplary method advantageously further includes impinging hot gases directly on the first area of the second printed circuit to reflow the additional solder layer.

Under the invention, a pallet assembly is provided for fixturing a pair of printed circuits, one or both of which feature a relatively-low-softening-temperature substrate such as PET or FR4, during a reflow of solder layer disposed between the printed circuits so as to contact a conductive trace of the first printed circuit at a first area on the first face of the first printed circuit's substrate. The pallet assembly includes a pallet having a mating surface for supporting the printed circuits proximate to the solder layer, with the first printed circuit's conductive traces overlying the conductive traces of the second printed circuit. The pallet assembly further includes a generally-flat cover having a mating surface adapted to be placed in opposition with a mating surface of the pallet, and a top surface generally opposite the mating surface.

A first portion of the cover defines a first aperture extending between the cover's top and mating surfaces, the first aperture being adapted to expose a second area on the second face of the first printed circuit, also defined by its substrate and generally aligned with the first area on the first printed circuit, such that hot gases directed at the top surface of the cover impinge directly upon the second area of the first printed circuit. The first portion of the cover is adapted to prevent a direct impingement of hot gases directed at the top surface of the cover onto a continuous perimeter of the second area of the first printed circuit. In this manner, the first portion of the cover shields the continuous perimeter of the second area of the first printed circuit's substrate from a direct impingement of hot gases during solder reflow.

In accordance with another aspect of the invention, the cover may advantageously include a second portion defining a second aperture, likewise extending between the cover's top and mating surfaces, adapted to expose an additional solder layer disposed on a first area on a first face of the second printed circuit that is not covered by the first printed circuit when they printed circuits are supported by the pallet. The second aperture thus permits hot gases directed at the top surface of the cover, to impinge directly upon the first area of the second printed circuit to reflow the additional solder layer, as when soldering one or more surface-mounted components on to the second printed circuit. In this manner, the invention advantageously provides for the electrical interconnection between a pair of printed circuits and component soldering in a single pass through a reflow oven. The pallet or the cover may further include a recess adapted to receive at least a portion of one of the printed circuits and, preferably, accommodate any components either previously soldered to, or to be simultaneously soldered onto, either of the printed circuits.

In accordance with yet another aspect of the invention, the pallet is preferably formed of a substantially-dimensionally-rigid, thermally-insulative material to minimize convection heating of the printed circuits while the pallet assembly advances through a reflow oven. The cover of the pallet assembly is preferably formed either of a thermally-insulative material or, alternatively, a thermally-conductive material, whereby unintended convection heating of each printed circuit's substrate is mitigated.

Additional features, benefits, and advantages of the invention will become apparent to those skilled in the art to which the invention relates from the subsequent description of several exemplary embodiments and the appended claims, taken in conjunction with the accompanying Drawings.

### BRIEF DESCRIPTION OF THE DRAWINGS

In the Drawings, wherein like reference numerals are used to designate like components in each of the several views, and wherein the relative thickness of certain components has been increased for clarity of illustration:

FIG. 1 is a view in cross-section of an exemplary method of practicing the invention, showing an exemplary pallet assembly traversing a reflow oven on a conveyor so as to direct an effluent stream of hot gases from a nozzle through a first aperture in the assembly's cover to thereby directly impinge upon the second (back) face of the first (upper) printed circuit only in the immediate vicinity of solder layers sandwiched between the two printed circuits and, subsequently, through a second aperture in the assembly's cover to thereby directly impinge upon the first (front) face of the lower printed circuit in the immediate vicinity of another solder layer to thereby electrically interconnect a surface-mounted component on to the lower printed circuit;

FIG. 2 is an enlarged view of the sandwiched, palletized printed circuits of the pallet assembly immediately before impingement of the hot gases onto the back face of the upper printed circuit;

FIG. 3 is a view of the mating surface of the pallet of the pallet assembly;

FIG. 4 is a view of the mating surface of the cover of the pallet assembly; and

FIG. 5 is an enlarged partial view of the mating surface of the cover proximate to the apertures through which impinging gases are directed during solder reflow.

### DETAILED DESCRIPTION OF THE INVENTION

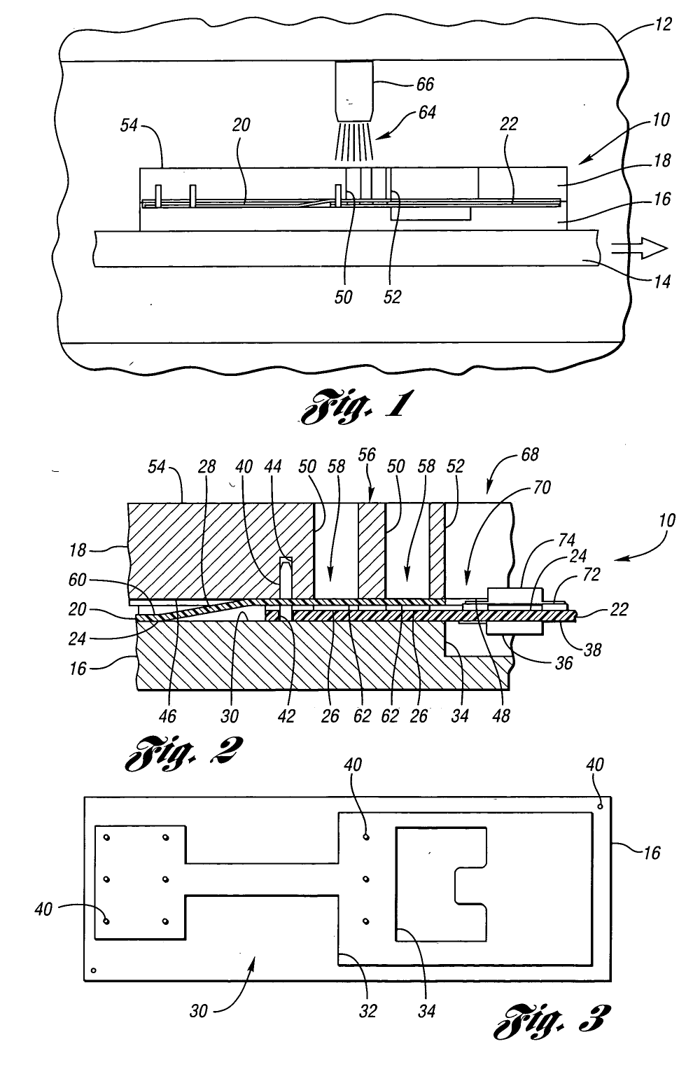

Referring to the Drawings, FIGS. 1 and 2 show an exemplary pallet assembly 10 traversing a reflow oven 12 on a conveyor 14, in accordance with an exemplary method of practicing the invention, while FIGS. 3-5 illustrate the first pallet assembly's pallet 16 and cover 18 in greater detail. As best seen in FIGS. 1 and 2, a pair of printed circuits 20, 22 are fixtured in the pallet assembly 10, such that the conductive traces respectively exposed on a first face 24 of each printed circuit 20, 22 are placed in opposition, and with solder layers 26 deposited on the first printed circuit 20 placed in touching contact with the respective traces on the first face 24 of the other printed circuit 22.

While the invention is suitable for use with printed circuits featuring a wide range of substrate materials and thicknesses, the invention is advantageously used to join one or more printed circuits having a thin, flexible polymeric substrate 28 formed, for example, of a relatively-low-softening-temperature material as PET or FR4. Similarly, while the solder layers 26 are conveniently dispensed onto the traces of the first printed circuit 20 as a solder paste, the solder layer 26 may be disposed between the respective traces of the printed circuits 20, 22 in any suitable manner, including use of a pre-plated solder, or a solder pre-form.

As best seen in FIG. 3, while the invention contemplates any suitable manner in which the two printed circuits are fixtured within the pallet assembly, the mating face 30 the assembly's pallet 16 advantageously features both a first recess 32 having a nominal footprint closely matching the footprint that will be defined by the two printed circuits 20, 22 upon interconnection. A second, nested recess 34 in the mating face 30 of the pallet 16 advantageously provides clearance for components 36 previously surface-mounted on the second face 38 of the second printed circuit 22 (as best shown in FIG. 2). The pallet 16 further advantageously features a plurality of alignment pins 40 projecting from the mating face 30 of the pallet 16.

As seen in FIG. 2, the alignment pins 40 extend through complementary alignment holes 42 defined in each printed circuit 20, 22 to thereby ensure alignment between the printed circuits 20, 22 is maintained during solder reflow. Alignment bores 44 defined in the mating surface 46 of the cover 18 similarly ensure a proper registration of the cover 18 with the pallet 16, once the cover 18 is clamped atop the pallet 16. The alignment bores 44 in the mating surface 46 of the cover 18, along with a recess 48 further accommodating the printed circuits 20, 22, are likewise clearly shown in FIG. 4.

Referring again to FIGS. 1 and 2, the cover 18 of the first pallet assembly 10 includes a several apertures 50, 52 extending between the cover's mating surface 46 and the top surface 54 of the cover. These apertures 50, 52, which are conveniently milled into the cover 18 without need for any draft angle, are also illustrated in greater detail in FIGS. 4 and 5.

As best seen in FIG. 2, two apertures 50, defined in a first portion 56 of the cover 18, are adapted to expose an area 58 on the second face 60 of the first printed circuit 20 that is generally aligned with an area 62 on the first face of the first printed circuit that includes the solder layers 26. As such, the first apertures 50 allow hot gases 64, which may constitute heated air, CO₂, argon, nitrogen, or any other suitable gas, flowing from a nozzle 66 within the reflow oven 12 to flow through the first apertures 50 and directly impinge upon the area 58 of the first printed circuit's substrate 28, thereby indirectly heating the solder layer 26 to a temperature sufficient to cause solder reflow and, hence, electrically-interconnect the two printed circuits 20, 22. The first portion 56 of the cover 18 continues to shield a continuous perimeter about the area 58 to thereby avoid unwanted heating of the substrate 28 by the effluent stream of hot gases 64 from the nozzle 66.

Referring again to FIGS. 1 and 2, the further aperture 52, defined in a second portion 68 of the cover 18, is adapted to expose an area 70 on the first face 24 of the second printed circuit 22, such that the hot gases 64 from the nozzle 66 directly impinge upon an additional solder layer 72 deposited on the second printed circuit 22 is reflowed, in the same pass through the reflow oven 12, to surface mount additional components 74 onto the second printed circuit 22.

It is noted that the pallet 16 is preferably formed of a substantially-dimensionally-rigid, thermally-insulative material to avoid an indirect heating of the supported printed circuits 20, 22 through the pallet 16 as the pallet assembly 10 is advanced through the reflow oven 12. By way of example, the pallet 16 is conveniently formed of a substantially-dimensionally-stable, thermally-insulative material, such as a fiberglass-resin engineered composite material known as a CBC material sold by Glastic Corporation of Cleveland, Ohio, and the cover 18 is formed of either a thermally-insulative material, such as that used for the pallet 16, or a thermally-conductive material, such as aluminum, in order to shield the respective substrates of the printed circuits 20, 22 from the hot gases 64 in areas 58, 70 other than those exposed by the apertures 50, 52. Where the cover 18 is formed of a thermally-conductive material, the cover 18 further serves to conduct heat away from the portions of the first printed circuit's substrate 28 with which the cover 18 is in touching contact, thereby further ensuring that an excessive substrate temperature due to convection heating during reflow is avoided.

While the above description constitutes a preferred embodiment, it will be appreciated that the invention is susceptible to modification, variation and change without departing from the proper scope and fair meaning of the subjoined claims. For example, while a nozzle 66 is preferably employed that has a configuration similar to that of the first apertures 50, defining an elongate nozzle opening extending generally transverse of the direction of travel of the conveyor 14, by which to direct impinging hot gases 64 onto the assembly's cover 18, it will be appreciated that the invention contemplates other nozzle configurations, including those disposed at an angle with respect to the first apertures 50, by which to direct impinging hot gases through the apertures 50, 52 of the assembly's cover 18.

Further, while the cover of the first pallet assembly is clamped to the pallet, the invention contemplates any suitable way to slightly bias the traces of one printed circuit toward the traces of the other printed circuit, proximate to the solder joints to be formed by solder reflow.

What is claimed is:

1. A method for reflow soldering a plurality of solder layers disposed between respective pairs of opposed conductive traces of a pair of overlapping printed circuits, wherein the first printed circuit has a polymeric substrate characterized by a relatively-low softening temperature that defines a first face supporting the conductive traces, and a second face opposite to the first face, the method comprising:
fixturing the first and second printed circuits between a respective mating surface of a pallet and a cover of a pallet assembly, wherein the pallet supports the printed circuits proximate to the solder layers, and wherein the cover includes a top surface generally opposite the mating surface of the cover, the cover further including a first portion defining a first aperture extending between the top and mating surfaces to expose a first area of the second face of the substrate of the first printed circuit generally underlying the solder layers, the first portion of the cover defining a perimeter of the first aperture that shields a continuous perimeter of the first area of the first printed circuit from a direct impingement of hot gases; and
directing hot gases at the top surface of the cover of the pallet assembly to impinge directly on the first area of the first printed circuit until the solder layers are heated to a predetermined reflow temperature.

2. The method of claim 1, wherein fixturing includes dimensioning the first portion of the cover including the first aperture and the continuous perimeter of the first aperture to prevent heating the continuous perimeter of the first area of the first printed circuit to a predetermined softening temperature.

3. The method of claim 1, wherein fixturing includes clamping the first and second printed circuits together proximate to the first area on the first printed circuit when directing hot gases through the first aperture of the cover, whereby the solder layers are maintained in contact with the respective traces of the first and second printed circuits during directing.

4. The method of claim 1, wherein one of the pallet and the cover includes a recess adapted to receive at least one of the printed circuits; and wherein fixturing includes'positioning the at least one of the printed circuits into the recess.

5. The method of claim 1, wherein the pallet includes an alignment pin projecting from the mating surface of the pallet, and the printed circuits each include an alignment bore adapted to receive the alignment pin of the pallet; and wherein fixturing includes placing the printed circuits onto the mating surface of the pallet such that the alignment pin extends through the respective alignment bores of the printed circuits.

6. The method of claim 1, wherein directing includes advancing the fixtured first and second printed circuits past a nozzle at a predetermined velocity, and supplying hot gases to the nozzle at a predetermined temperature and flow rate.

7. The method of claim 1, further including conducting heat away from the first portion of the cover.

8. The method of claim 1, wherein the cover of the pallet assembly includes a second portion having a second aperture extending between the mating surface and the top surface to expose an additional solder layer on a first area of the second printed circuit that is not covered by the first printed circuit during fixturing, and wherein directing includes impinging hot gases directly on the first area of the second printed circuit to reflow the additional solder layer.

9. A pallet assembly for fixturing a pair of printed circuits during a reflow of a solder layer disposed between the printed circuits, wherein the first printed circuit includes a substrate defining a first face supporting a plurality of exposed conductive traces and a second face opposite the first face, the solder layer contacts a conductive trace of the first printed circuit at a first area on the first face, and the second face of the first printed circuit includes a second area generally aligned with the first area and bounded by a continuous perimeter, the pallet assembly comprising:
a pallet including a mating surface for supporting the printed circuits proximate to the solder layer; and
a generally-flat cover including a mating surface adapted to be placed in opposition with the mating surface of the pallet, and a top surface generally opposite the mating surface, wherein a first portion of the cover defines a first aperture extending between the top and mating surfaces, the first aperture being adapted to expose the second area of the first printed circuit when the printed circuits are supported by the pallet such that hot gases directed at the top surface of the cover impinge directly upon the second area of the first printed circuit, and wherein the first portion of the cover is adapted to prevent a direct impingement of hot gases directed at the top surface of the cover onto the continuous perimeter of the second area of the first printed circuit.

10. The pallet assembly of claim 9, wherein the cover includes a second portion defining a second aperture extending between the top and mating surfaces, the second aperture being adapted to expose an additional solder layer disposed on a first area on a first face of the second printed circuit that is not covered by the first printed circuit when the printed circuits are supported by the pallet, such that hot gases directed at the top surface of the cover impinge directly upon the first area of the second printed circuit to reflow the additional solder layer.

11. The pallet assembly of claim 9, wherein the mating surface of one of the pallet and the cover includes a first recess adapted to receive at least a portion of one of the printed circuits.

12. The pallet assembly of claim 11, wherein the mating surface of one of the pallet and the cover includes a second recess adapted to provide clearance for a component mounted on one of the printed circuits.

13. The pallet assembly of claim 9, wherein one of the pallet and the cover includes an alignment pin projecting from the mating surface thereof, and wherein the mating surface of the other of the pallet and the cover includes an alignment bore adapted to receive the alignment pin when the cover is positioned atop the pallet in registration with the pallet.

14. The pallet assembly of claim 9, wherein the pallet is formed of a substantially-dimensionally-rigid, thermally-insulative material.

15. The pallet assembly of claim 14, wherein the cover is formed of a thermally-insulative material.

16. The pallet assembly of claim 14, wherein the cover is formed of a thermally-conductive material.

17. A pallet assembly for fixturing a first printed circuit and a second printed circuit during a reflow of a plurality of closely-spaced solder layers disposed between respective pairs of conductive traces of the first and second printed circuits, wherein the first printed circuit includes a substrate defining a first face supporting the traces of the first printed circuit and a second face opposite the first face, the pallet assembly comprising:
a pallet including a mating surface for supporting the printed circuits beneath a first area on the first face of the first printed circuit encircling the solder layers; and
a generally-flat cover including a mating surface adapted to be placed in opposition with the mating surface of the pallet, and a top surface opposite the mating surface, wherein a first portion of the cover defines a first aperture extending between the top and mating surfaces, the first aperture being adapted to expose a second area on the back face of the first printed circuit generally aligned with the first area when the printed circuits are supported by the pallet such that hot gases directed at the top surface of the cover impinge directly upon the second area of the first printed circuit, and wherein the first portion of the cover is adapted to prevent a direct impingement of hot gases directed at the top surface of the cover onto a continuous perimeter of the second area of the first printed circuit.

18. The pallet assembly of claim 17, wherein the cover includes a second portion defining a second aperture extending between the top and mating surfaces, the second aperture being adapted to expose an additional solder layer disposed on a first area of the second printed circuit that is not covered by the first printed circuit when the printed circuits are supported by the pallet, such that hot gases directed at the top surface of the cover impinge directly upon the first area of the second printed circuit to reflow the additional solder layer.

19. The pallet assembly of claim 17, wherein one of the pallet and cover includes a first recess adapted to receive at least a portion of one of the printed circuits.

20. The pallet assembly of claim 19, wherein the one of the pallet and cover includes a second recess adapted to provide clearance for a component mounted on the second printed circuit proximate to the first area of the second printed circuit.
